(19) United States
(12) Patent Application Publication
(10) Pub. No.: US 2011/0056114 A1
(43) Pub. Date: Mar. 10, 2011

(54) Straight Fishing Hook

(76) Inventor: Nane Capeski, Sydney, NSW (AU)

(21) Appl. No.: 12/866,262

(22) PCT Filed: Feb. 5, 2009
(86) PCT No.: PCT/AU2009/000139

§ 371 Date: Aug. 5, 2010

(30) Foreign Application Priority Data
Feb. 7, 2008 (AU) 2008100112

(51) Int. Cl. A01K 83/00

(52) U.S. Cl. 43/43.16

(57) ABSTRACT

A Straight Fishing Hook comprising a primary hook (1) with an elongated body (2) having an eyelet at the opposite end (3) and second hook (4) attached by its shank to the elongated body at approximately four fifth of the length of the elongate body measured from the eyelet, the second hook extending at a 90 degree angle to the primary hook; a third hook (5) attached by its shank to the elongated body at approximately three fifth of the length of the elongate body measured from the eyelet, the third hook extending at a 180 degree angle to the primary hook; a fourth hook (6) attached by its shank to the elongated body at approximately two fifth of the length of the elongate body measured from the eyelet, the fourth hook extending at a 270 degree angle to the primary hook.

### DESCRIPTION

A Straight Fishing Hook (refer to drawings figure one) comprising a primary hook (1) with an elongated body (2) having an eyelet at the opposite end (3) and second hook (4) attached by its shank to the elongated body at approximately four fifth of the length of the elongate body measured from the eyelet, the second hook extending at a 90 degree angle to the primary hook; a third hook (5) attached by its shank to the elongated body at approximately three fifth of the length of the elongate body measured from the eyelet, the third hook extending at a 180 degree angle to the primary hook; a fourth hook (6) attached by its shank to the elongated body at approximately two fifth of the length of the elongate body measured from the eyelet, the fourth hook extending at a 270 degree angle to the primary hook.

This invention relates to the successful integration of multiple fishing hooks with a primary fishing hook thus creating the Straight Fishing Hook.

The first innovation of the Straight Fishing Hook includes a primary hook with elongated body, the innovation exists as the body being elongated corresponds with the body structure of most fishing bait e.g: a fish spine, prawns etc allowing the Straight Fishing Hook to be placed easily through the bait providing support throughout the majority of the bait.

The second innovation of the Straight Fishing Hook includes a primary hook number one, hook number two, hook number three and hook number four, the innovation exists as the straight fishing hook when placed into the fishing bait and thrown into the water the above mentioned hooks firstly prevents the fishing bait from falling off the Straight Fishing hook as the hooks are positioned in a spiral order to support independently various places of the fishing bait and/or various fishing baits placed on individual hooks and secondly the hooks provide multiple places for the fishes/water creatures to be hooked and caught.

The Straight Fishing hook can be made of High-Carbon Steel, Steel Alloyed with Vanadium or Stainless Steel depending on the embodiment and application. Some of the embodiments will require to be covered with some form of Corrosion Resistant Surface Coating or colouring.

### SCOPE OF THE INVENTION

This invention relates to fishing hooks and fishing devices or the like which are used for fishing.

The invention integrates multiple fishing hooks with a primary fishing hook thus creating the Straight Fishing Hook.

The Straight fishing hook can be used as an innovative alternative for a fishing hook and in accordance with its present innovation can be envisaged as a successful and effective replacement for other fishing hooks, devices etc that are currently used to apply fishing bait too and catch fish/other water creatures.

### PRIOR ART

Fishing Hook may refer to The fish hook is a device for catching fish either by impaling them in the mouth or, more rarely, by snagging the body of the fish.

Fish and other Water/Sea Creatures and Marine Animals.

Fish: are aquatic vertebrates that are cold-blooded, covered with scales, and equipped with two sets of paired fins and several unpaired fins. Fish are abundant in the sea and in fresh water, with species being known from mountain streams as well as in the deepest depths of the ocean. They are of tremendous importance as food for people around the world, either collected from the wild (fishing) or farmed in much the same way as cattle or chickens (aquaculture). Fish are also exploited for recreation, through recreational fishing, angling and fishkeeping. Fish have an important role in many cultures through the ages, ranging as widely as deities and religious symbols to subjects of books and popular movies.

Live Bait fishing has been for a long time the preferred way of fishing. Today we have many other artificial baits, but even so live bait fishing remains the preference for fishermen.

The problem with conventional bait fishing tackle is it does not often prove to be successful and it is not always suitable for all types of bait. Firstly bait has traditionally been placed on a fishing hook or device and when the fishing rod/device is cast the bait is thrown off. Secondly fish are sometimes able to remove the bait from the fishing hook/device without being hooked. Thirdly conventional bait tackle does not properly support various sizes and types of bait. It is beneficial for the bait to be fitted to the bait tackle to remain in its natural form. The Straight fishing hook allows bait to be applied straight thus maintaining the natural shape and form of the bait. The Multiple hooks allows all types of baits to be held in various spots, thus lowering the possibility of the bait coming off.

### THOROUGH DESCRIPTION OF PREFERRED EMBODIMENT

A Straight Fishing Hook (refer to drawings figure one) comprising a primary hook (1) with an elongated body (2) having an eyelet at the opposite end (3) and second hook (4) attached by its shank to the elongated body at approximately four fifth of the length of the elongate body measured from the eyelet, the second hook extending at a 90 degree angle to the primary hook; a third hook (5) attached by its shank to the elongated body at approximately three fifth of the length of the elongate body measured from the eyelet, the third hook extending at a 180 degree angle to the primary hook; a fourth hook (6) attached by its shank to the elongated body at approximately two fifth of the length of the elongate body measured from the eyelet, the fourth hook extending at a 270 degree angle to the primary hook.

Although the above description contains many specifications, these should not be constructed as limiting the scope of the invention, but simply providing illustrative examples of some of the presently preferred embodiments of this invention. All such other modifications and variations thereto would be perceptible to professionals skilled in the art and would be regarded to fall within the broad scope. Thus the scope of the invention should be determined by the appended claims and their legal equivalents.

### DESCRIPTION OF THE DRAWINGS

The innovation is further described by reference to the illustrations detailing the preferred embodiment and other possible embodiments:

FIG. 1 is the Front View of the Straight Fishing Hook with details of the present innovation.

FIG. 2 is the Back View of the Straight Fishing Hook with details of the present innovation.

FIG. 3 is the Right Side View of the Straight Fishing Hook with details of the present innovation.

FIG. 4 is the Left Side View of the Straight Fishing Hook with details of the present innovation.

FIG. 5 is the View of the Straight Fishing Hook placed inside a bait (Inserted through to the mouth of a Pilchard Fish)

FIG. 6: Front View of a Straight Fishing Hook in a different embodiment comprising of Eight Hooks.

1. A Straight Fishing Hook (refer to drawings figure one) comprising a primary hook (1) with an elongated body (2) having an eyelet at the opposite end (3) and second hook (4) attached by its shank to the elongated body at approximately four fifth of the length of the elongate body measured from the eyelet, the second hook extending at a 90 degree angle to the primary hook; a third hook (5) attached by its shank to the elongated body at approximately three fifth of the length of the elongate body measured from the eyelet, the third hook extending at a 180 degree angle to the primary hook; a fourth hook (6) attached by its shank to the elongated body at approximately two fifth of the length of the elongate body measured from the eyelet, the fourth hook extending at a 270 degree angle to the primary hook.

2. A straight fishing Hook according to claim 1 wherein the elongated body corresponds with the body structure of most fishing bait e.g.: a fish spine, prawns etc, allowing the Straight Fishing Hook to be placed easily through the bait mouth providing support throughout the majority of the bait.

3. A Straight Fishing Hook according to claim 1 when placed into the fishing bait and thrown into the water the above mentioned hooks firstly prevents the fishing bait from falling off the Straight Fishing hook as the hooks are positioned in a spiral order to support independently various places of the fishing bait and/or various fishing baits placed on individual hooks and secondly the hooks provide multiple places for the fishes/water creatures to be hooked and caught.

4. A Straight Fishing Hook according to claim 1 can be made of High-Carbon Steel, Steel Alloyed with Vanadium or Stainless Steel depending on the embodiment and application. Some of the embodiments will require to be covered with some form of Corrosion Resistant Surface Coating or colouring.

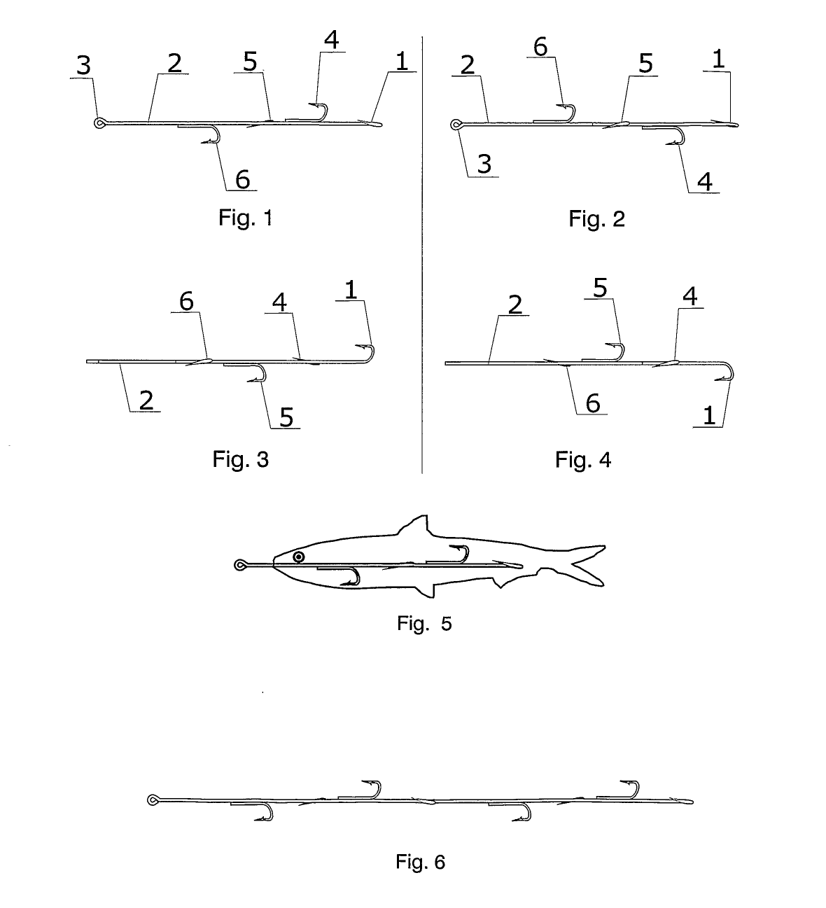

5. A Straight Fishing Hook substantially as herein before described and with other various embodiments with reference to FIGS. 1-5 of the accompanying drawings:
